(19) United States
(12) Patent Application Publication
(10) Pub. No.: US 2026/0326542 A1
(43) Pub. Date: Oct. 22, 2026

(54) VEHICLE CONTROL APPARATUS

(71) Applicant: SUBARU CORPORATION, Tokyo (JP)

(72) Inventor: Koji MATSUNO, Tokyo (JP)

(21) Appl. No.: 19/573,382

(22) Filed: Mar. 20, 2026

(30) Foreign Application Priority Data
Apr. 18, 2025 (JP) 2025-069022

(51) Int. Cl. B60K 23/04; B60K 17/16

(52) U.S. Cl. CPC B60K 23/04; B60K 17/165; B60K 2023/043

(57) ABSTRACT

A vehicle control apparatus is configured to control a vehicle including a differential device. The differential device includes a differential mechanism and a limited slip differential. The differential mechanism is configured to distribute driving force between inner and outer turning wheels. The limited slip differential is configured to restrict differential rotation between the inner and outer turning wheels. The vehicle control apparatus includes one or more processors and one or more memories communicably coupled to the one or more processors. The one or more processors are configured to calculate a driving force difference, based on a rotation speed difference. The driving force difference is a value representing driving force of the outer turning wheel minus driving force of the inner turning wheel. The rotation speed difference is a value representing a rotation speed of the outer turning wheel minus a rotation speed of the differential device.

### CROSS-REFERENCE TO RELATED APPLICATIONS

The present application claims priority from Japanese Patent Application No. 2025-069022 filed on Apr. 18, 2025, the entire contents of which are hereby incorporated by reference.

### BACKGROUND

The disclosure relates to a vehicle control apparatus.

A vehicle such as an automobile includes a differential device that distributes driving force output from a driving power source, such as an engine or a drive motor, to right and left driving wheels. The differential device includes a differential mechanism housed within a case, and ensures a smooth turn of the vehicle by distributing the driving force to the right and left driving wheels so as to cause differential rotation when the vehicle turns.

As one example of the differential device, a differential device is disclosed that includes a limited slip differential that restricts the differential rotation caused by the differential mechanism. For example, if the differential mechanism distributes the driving force to an inner turning wheel of the vehicle lifting off the ground due to centrifugal force upon high-speed turning on a sharp curve, the inner turning wheel can spin. This can reduce the driving force to be distributed to the outer wheel remaining in contact with the ground, and decrease the speed upon turning. In such a case, the limited slip differential ensures high traveling performance of the vehicle by restricting the differential rotation to suppress spinning of the inner turning wheel.

Japanese Unexamined Patent Application Publication (JP-A) No. 2007-239819 discloses a differential limiting control device that achieves good steering characteristics regardless of a vehicle traveling state by controlling differential limiting force between right and left wheels. In the technique described in JP-A No. 2007-239819, for example, a yaw rate correspondence control amount is calculated upon turning of a vehicle, based on a deviation between an actual yaw rate and a target yaw rate, and a current steering characteristic of the vehicle and a magnitude relation between the wheel speeds of the right and left front wheels of the vehicle are determined. In accordance with the combination of the steering characteristic and the magnitude relation between the wheel speeds, a base control amount is compensated toward an increase or decrease side, based on the yaw rate correspondence control amount, and the differential limiting force between right and left front wheels is controlled, based on a final control amount obtained after the compensation.

In the technique disclosed in JP-A No. 2007-239819, during operation of the differential mechanism, a driving force difference is generated between the right and left wheels, in accordance with a transfer direction of the driving force transferring between the right and left wheels and a capacity of differential limiting torque (a maximum value of the driving force transferrable between the right and left wheels) generated by the differential limiting mechanism. This allows the steering characteristic of the vehicle to be controlled as targeted, while estimating a yaw moment to act on the vehicle.

However, if the differential limiting torque generated by the differential limiting mechanism increases and the differential mechanism is locked beyond a grip limit of the wheels, for example, the capacity of the differential limiting torque and the driving force actually transferring between the right and left wheels deviate from each other, making it difficult to quantitatively estimate and control the yaw moment to act on the vehicle.

It is desirable to provide a vehicle control apparatus that makes it possible to control a yaw moment to act on a vehicle, based on a driving force difference generated between inner and outer turning wheels, even when a differential mechanism is locked beyond a grip limit of the wheels.

### SUMMARY

An aspect of the disclosure provides a vehicle control apparatus configured to control a vehicle. The vehicle includes a differential device including a differential mechanism and a limited slip differential. The differential mechanism is configured to distribute driving force between an inner turning wheel and an outer turning wheel. The limited slip differential is configured to restrict differential rotation between the inner turning wheel and the outer turning wheel. The vehicle control apparatus includes one or more processors and one or more memories. The one or more processors are configured to calculate a driving force difference, based on a rotation speed difference. The driving force difference is a value representing the driving force of the outer turning wheel minus the driving force of the inner turning wheel, The rotation speed difference is a value representing a rotation speed of the outer turning wheel minus a rotation speed of the differential device. The one or more memories are communicably coupled to the one or more processors.

### BRIEF DESCRIPTION OF THE DRAWINGS

The accompanying drawings are included to provide a further understanding of the disclosure and are incorporated in and constitute a part of this specification. The drawings illustrate example embodiments and, together with the specification, serve to explain the principles of the disclosure.

FIG. 1 is a schematic diagram of an exemplary configuration of a vehicle including a vehicle control apparatus according to one example embodiment of the disclosure.

FIG. 2 is a block diagram of an exemplary configuration of the vehicle control apparatus illustrated in FIG. 1.

FIG. 3 is a graph illustrating an example of estimated driving force difference data to be obtained by the vehicle control apparatus illustrated in FIG. 1.

FIG. 4 is a graph illustrating another example of the estimated driving force difference data to be obtained by the vehicle control apparatus illustrated in FIG. 1.

FIG. 5 is a graph illustrating another example of the estimated driving force difference data to be obtained by the vehicle control apparatus illustrated in FIG. 1.

FIG. 6 is an explanatory diagram illustrating driving force of an outer turning wheel and driving force of an inner turning wheel to be generated when a vehicle turns left in a state where both the outer turning wheel and the inner turning wheel are gripping.

FIG. 7 is a graph illustrating another example of the estimated driving force difference data to be obtained by the vehicle control apparatus illustrated in FIG. 1.

FIG. 8 is an explanatory diagram illustrating driving force of the outer turning wheel and driving force of the inner turning wheel to be generated when the vehicle turns left in a state where both the outer turning wheel and the inner turning wheel are slipping.

FIG. 9 is a flowchart of an exemplary routine of a processing operation of the vehicle control apparatus illustrated in FIG. 1.

FIG. 10 is a flowchart of an exemplary routine of the processing operation of the vehicle control apparatus illustrated in FIG. 1.

FIG. 11 is a graph illustrating an exemplary setting of a differential limiting torque to be performed by the vehicle control apparatus illustrated in FIG. 1.

### DETAILED DESCRIPTION

In the following, some example embodiments of the disclosure are described in detail with reference to the accompanying drawings. Note that the following description is directed to illustrative examples of the disclosure and not to be construed as limiting to the disclosure. Factors including, without limitation, numerical values, shapes, materials, components, positions of the components, and how the components are coupled to each other are illustrative only and not to be construed as limiting to the disclosure. Further, elements in the following example embodiments which are not recited in a most-generic independent claim of the disclosure are optional and may be provided on an as-needed basis. The drawings are schematic and are not intended to be drawn to scale. Throughout the present specification and the drawings, elements having substantially the same function and configuration are denoted with the same reference numerals to avoid any redundant description. In addition, elements that are not directly related to any embodiment of the disclosure are unillustrated in the drawings. Herein, the term “driven wheel” refers to a front wheel or rear wheel of a vehicle whichever receives a smaller driving force distribution (including a case where the distributed driving force is zero). In the following example embodiments, a larger amount of the driving force is distributed to the rear wheel and thus the front wheel corresponds to the driven wheel.

### <1. Configuration of Vehicle>

First, a description will be given of an exemplary overall configuration of a vehicle including a vehicle control apparatus according to an example embodiment.

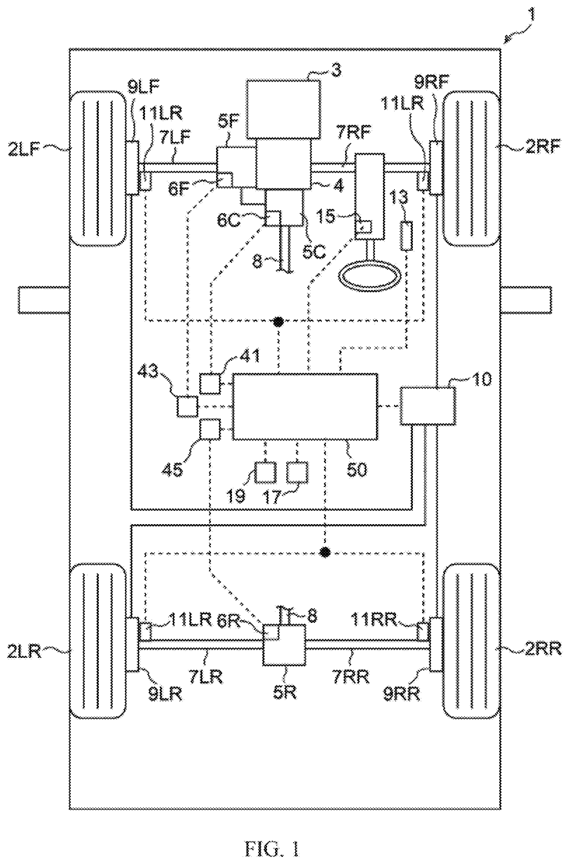

FIG. 1 schematically illustrates an exemplary configuration of a vehicle 1. The vehicle 1 may be a four-wheel drive vehicle including a left-front wheel 2LF, a right-front wheel 2RF, a left-rear wheel 2LR, and a right-rear wheel 2RR. Hereinafter, the left-front wheel 2LF, the right-front wheel 2RF, the left-rear wheel 2LR, and the right-rear wheel 2RR may be collectively referred to as “wheels 2” when there is no need to distinguish among them. The left-front wheel 2LF and the right-front wheel 2RF may also be referred to as “front wheels 2F”, and the left-rear wheel 2LR and the right-rear wheel 2RR may also be referred to as “rear wheels 2R”.

The vehicle 1 may include a driving power source 3, a transmission 4, a center differential device 5C, a front differential device 5F, a rear differential device 5R, a brake hydraulic processor 10, brake devices 9 (9LF, 9RF, 9LR, and 9RR), wheel speed sensors 11 (11LF, 11RF, 11LR, and 11RR), an accelerator position sensor 13, a steering angle sensor 15, an acceleration sensor 17, a yaw rate sensor 19, a center LSD driver 41, a front LSD driver 43, a rear LSD driver 45, and a vehicle control apparatus 50.

The driving power source 3 may be an internal combustion engine, such as a gasoline engine or a diesel engine, or a drive motor. The driving power source 3 may include both an internal combustion engine and a drive motor. In a case where the vehicle 1 is an electric vehicle or a hybrid electric vehicle, the vehicle 1 may include a secondary battery that stores electric power to be supplied to the drive motor, or a power generator such as a motor or a fuel cell that generates electric power with which the battery is to be charged.

The transmission 4 may transmit driving force output from the driving power source 3 to the center differential device 5C. In some embodiments, the transmission 4 may include a continuously or non-continuously variable transmission mechanism, a torque converter, and a forward/reverse shifting mechanism.

The center differential device 5C may distribute the driving force transmitted from the transmission 4 to the front differential device 5F and the rear differential device 5R. The center differential device 5C may include a differential mechanism that causes differential rotation between the front differential device 5F and the rear differential device 5R, and a limited slip differential (hereinafter also referred to as a center LSD) 6C that restricts the differential rotation caused by the differential mechanism.

The center LSD 6C may include an electromagnetic or hydraulic clutch that restricts differential rotation between an output unit of the center differential device 5C adjacent to the front differential device 5F and an output unit of the center differential device 5C adjacent to the rear differential device 5R. The center LSD 6C may be an electronically-controlled LSD configured to generate differential limiting torque in accordance with a command from the vehicle control apparatus 50 and vary the restriction force (clutch engaging force). The differential limiting torque of the center LSD 6C may be controlled by the center LSD driver 41.

The front differential device 5F may be an axle differential device located between an axle 7LF of the left-front wheel 2LF and an axle 7RF of the right-front wheel 2RF of the vehicle 1. The front differential device 5F may distribute the driving force transmitted from the center differential device 5C to the left-front wheel 2LF and the right-front wheel 2RF. The front differential device 5F may include a differential mechanism that causes differential rotation between the left-front wheel 2LF and the right-front wheel 2RF, and a limited slip differential (hereinafter also referred to as a front LSD) that restricts the differential rotation caused by the differential mechanism.

The front LSD 6F may include an electromagnetic or hydraulic clutch that restricts differential rotation between the axle 7LF of the left-front wheel 2LF and the axle 7RF of the right-front wheel 2RF. The front LSD 6F may be an electronically-controlled LSD configured to generate differential limiting torque in accordance with a command from the vehicle control apparatus 50 and vary the restriction force. The axle 7LF of the left-front wheel 2LF may be located between the front differential device 5F and the left-front wheel 2LF, and the axle 7RF of the right-front wheel 2RF may be located between the front differential device 5F and the right-front wheel 2RF. The differential limiting torque of the front LSD 6F may be controlled by the front LSD driver 43.

The rear differential device 5R may be an axle differential device located between an axle 7LR of the left-rear wheel 2LR and an axle 7RR of the right-rear wheel 2RR of the vehicle 1. The center differential device 5C may transmit the driving force to the rear differential device 5R via a propeller shaft 8. The rear differential device 5R may distribute the driving force transmitted from the center differential device 5C to the left-rear wheel 2LR and the right-rear wheel 2RR. The rear differential device 5R may include a differential mechanism that causes differential rotation between the left-rear wheel 2LR and the right-rear wheel 2RR, and a limited slip differential (hereinafter also referred to as a rear LSD) that restricts the differential rotation caused by the differential mechanism.

The rear LSD 6R may include an electromagnetic or hydraulic clutch that restricts differential rotation between the axle 7LR of the left-rear wheel 2LR and the axle 7RR of the right-rear wheel 2RR. The rear LSD 6R may be an electronically-controlled LSD configured to generate differential limiting torque in accordance with a command from the vehicle control apparatus 50 and vary the restriction force. The axle 7LR of the left-rear wheel 2LR may be located between the rear differential device 5R and the left-rear wheel 2LR, and the axle 7RR of the right-rear wheel 2RR may be located between the rear differential device 5R and the right-rear wheel 2RR. The differential limiting torque of the rear LSD 6R may be controlled by the rear LSD driver 45.

The brake devices 9 may be provided on the wheels 2, respectively, and apply braking force to the corresponding wheels 2. In some embodiments, the brake devices 9 may be hydraulic brake devices. The brake hydraulic processor 10 may control a brake hydraulic pressure to be applied to the brake devices 9 in accordance with a driving command received from the vehicle control apparatus 50, thereby generating predetermined braking force. In a case where the vehicle 1 is an electric vehicle or a hybrid electric vehicle, the brake devices 9 may be used in combination with regenerative braking force generated by the drive motor.

In some embodiments, the wheel speed sensor 11 may be disposed in a hub bearing housing that rotatably supports each wheel 2. The wheel speed sensor 11 may output a sensor signal in accordance with a rotation speed of the wheel 2. The vehicle control apparatus 50 may read the sensor signal received from the wheel speed sensor 11 and calculate a rotation speed of each wheel 2.

In some embodiments, the accelerator position sensor 13 may be disposed on an accelerator pedal, and may output a sensor signal in accordance with an operation amount of the accelerator pedal operated by a driver who drives the vehicle 1. A control unit that controls the driving power source 3 may read the sensor signal received from the accelerator position sensor 13, calculate requested driving force, based on the operation amount of the accelerator pedal operated by the driver, and control output of the driving power source 3.

In some embodiments, the steering angle sensor 15 may be disposed on a steering column, and may output a sensor signal in accordance with a rotation angle of a steering wheel. The acceleration sensor 17 may output a sensor signal corresponding to longitudinal and lateral acceleration acting on the vehicle body. The yaw rate sensor 19 may output a sensor signal corresponding to a yaw rate, which is an angular velocity of rotation about a vertical axis of the vehicle body.

The center LSD driver 41, the front LSD driver 43, and the rear LSD driver 45 may supply driving force to the respective clutches of the center LSD 6C, the front LSD 6F, and the rear LSD 6R, in accordance with a command from the vehicle control apparatus 50, and vary the restriction force of the center LSD 6C, the front LSD 6F, and the rear LSD 6R.

The vehicle control apparatus 50 includes one or more electronic control units that control the vehicle 1. The vehicle control apparatus 50 serves as an apparatus that controls the driving force of the vehicle body by causing one or more processors such as central processing units (CPUs) to execute a computer program. The computer program may cause the one or more processors to perform a later-described operation to be executed by the vehicle control apparatus 50. The computer program to be executed by the one or more processors may be recorded in a recording medium serving as a storage (memory) 61 provided in the vehicle control apparatus 50, or may be recorded in any recording medium incorporated in the vehicle control apparatus 50 or externally attachable to the vehicle control apparatus 50.

Examples of the recording medium in which the computer program is recorded may include: a hard disc; a magnetic medium such as a floppy disc or a magnetic tape; an optical recording medium such as a compact disc read-only memory (CD-ROM), a digital versatile disc (DVD), or a Blu-ray (registered trademark); a magnetooptical medium such as a floptical disc; a memory such as a random access memory (RAM) or a read-only memory (ROM); a flash memory such as a universal serial bus memory (USB) or a solid state drive (SSD); and another medium configured to store programs.

### <2. Vehicle Control Apparatus>

Next, a description will be given in detail of the vehicle control apparatus 50 according to the present example embodiment.

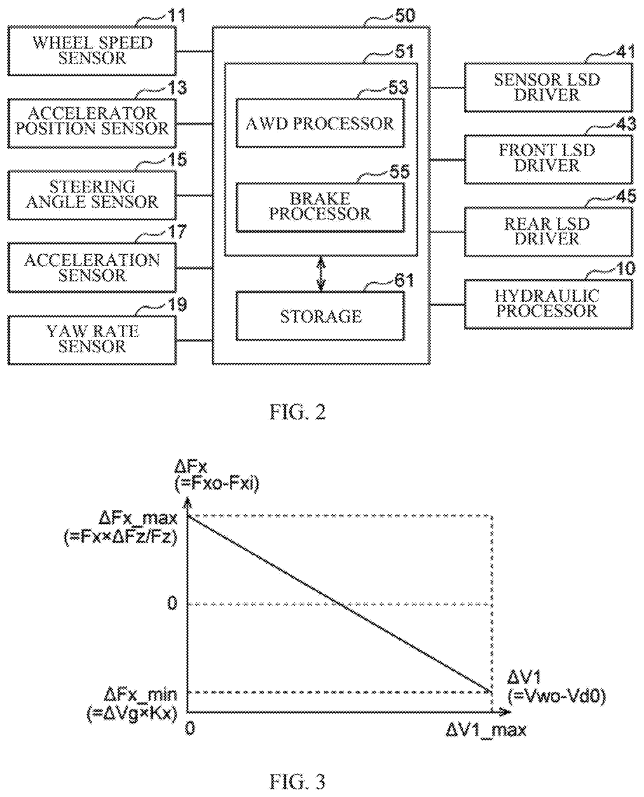

FIG. 2 is a block diagram illustrating an exemplary configuration of the vehicle control apparatus 50. The vehicle control apparatus 50 includes a processing unit 51 and a storage 61. The processing unit 51 may include one or more processors such as CPUs and various peripheral components. In some embodiments, a part or the entirety of the processing unit 51 may be configured by updatable software, or may be a program module to be executed by the CPU.

The storage 61 may include one or more memories such as RAMs or ROMs communicably coupled to the processing unit 51. The storage 61 is not particularly limited in type or number. The storage 61 may store data such as a computer program to be executed by the processing unit 51, various parameters to be used in calculation processing, detected data, or results of calculation. A part of the storage 61 may be used as a work area of the processing unit 51.

The wheel speed sensor 11, the accelerator position sensor 13, the steering angle sensor 15, the acceleration sensor 17, and the yaw rate sensor 19 may be coupled to the vehicle control apparatus 50 via a dedicated network or a communication means such as a controller area network (CAN) or a local interconnect network (LIN).

The processing unit 51 may include an all-wheel drive (AWD) processor 53 and a brake processor 55. The AWD processor 53 and the brake processor 55 may be operated in accordance with a computer program executed by the one or more processors. A part of the AWD processor 53 and the brake processor 55 may be configured by hardware such as analog circuitry.

In the following, operations of the AWD processor 53 and the brake processor 55 will be briefly described, following which processing to be performed by these components will be described.

The AWD processor 53 may issue commands to the center LSD driver 41, the front LSD driver 43, and the rear LSD driver 45 in accordance with a traveling state of the vehicle 1, thereby controlling the differential limiting torque to be generated in the center LSD 6C, the front LSD 6F, and the rear LSD 6R. In some embodiments, when the vehicle 1 turns with acceleration, the AWD processor 53 may bring the front LSD 6F and the rear LSD 6R into a locked (engaged) state and increases the differential limiting torque in accordance with an increase in slip of the inner turning wheel caused by an increase in driving force applied to the inner turning wheel. By performing such control, the driving force may be transferred from the inner turning wheel to the outer turning wheel, thereby increasing the driving force of the outer turning wheel and generating a yaw moment in an oversteer direction. Further, in a state where the inner turning wheel grips sufficiently, the AWD processor 53 may bring the front LSD 6F and the rear LSD 6R into the locked (engaged) state and increases the differential limiting torque. By performing such control, the differential rotation between the inner turning wheel and the outer turning wheel may be made zero, thereby generating a yaw moment in an udersteer direction in accordance with a difference in passage track between the inner turning wheel and the outer turning wheel.

In the present example embodiment, when the differential rotation between the outer turning wheel and the inner turning wheel is not zero and the direction of the yaw moment generated by the differential rotation (turning direction of the vehicle body) and the direction of a target yaw moment are identical to each other, the AWD processor 53 may achieve the target yaw moment by controlling the differential limiting torque of one or both the front LSD 6F and the rear LSD 6R. Further, when the differential rotation between the outer turning wheel and the inner turning wheel is not zero and the direction of the yaw moment generated by the differential rotation and the direction of the target yaw moment are not identical to each other, the AWD processor 53 may achieve the target yaw moment by controlling a control element other than the front LSD 6F and the rear LSD 6R.

In contrast, when the differential rotation between the outer turning wheel and the inner turning wheel is zero, the AWD processor 53 may calculate a driving force difference between the driving force of the outer turning wheel and the driving force of the inner turning wheel, based on a rotation speed difference between the rotation speed of the outer turning wheel, which is a driven wheel, and the rotation speed of the differential device.

Based on the calculated driving force difference, the AWD processor 53 may calculate an acting yaw moment action on the vehicle 1, and convert the acting yaw moment into the differential limiting torque of the front LSD 6F or the rear LSD 6R. In other words, the AWD processor 53 may calculate the differential limiting torque generated by the front LSD 6F or the rear LSD 6R from the value of the acting yaw moment. When the acting yaw moment is smaller than the target yaw moment of the vehicle 1, the AWD processor 53 may achieve the target yaw moment by generating an additional yaw moment, which is a shortfall of the yaw moment, using a control element other than the front LSD 6F and the rear LSD 6R.

The brake processor 55 may issue a command to the brake hydraulic processor 10 in accordance with a braking operation performed by the driver or a traveling state of the vehicle 1, thereby controlling braking force to be generated by the respective brake devices 9 of the wheels 2. The brake devices 9 may individually generate a brake hydraulic pressure to be applied to the brake devices 9 of the wheels 2 in accordance with the command from the brake processor 55, thereby generating the braking force at each wheel 2. In the present example embodiment, when the AWD processor 53 has a difficulty in generating a sufficient yaw moment solely by controlling the front LSD 6F and the rear LSD 6R, the brake processor 55 may generate an additional yaw moment, which is a shortfall of the yaw moment, by individually causing the brake devices 9 to generate the braking force at the corresponding wheels 2.

### <3. Calculation Method of Driving Force Difference>

Next, a description will be given of how the AWD processor 53 of the vehicle control apparatus 50 calculates the driving force difference between the driving force of the outer turning wheel and the driving force of the inner turning wheel.

Hereinafter, for convenience of explanation, a method of calculating the driving force difference between the driving force of the outer turning wheel and the driving force of the inner turning wheel of the rear wheels 2R is described as an example. The term “driving wheels” may refer to the rear wheels 2R, and the term “driven wheels” may refer to the front wheels 2F. The terms “outer turning wheel”, “inner turning wheel”, and “inner and outer turning wheels” may refer to inner and/or outer turning wheels out of the rear wheels 2R, and the term “outer driven wheel” may refer to an outer turning wheel out of the front wheels 2F, unless otherwise stated.

In the present example embodiment, the AWD processor 53 may calculate the driving force difference between the driving force of the outer turning wheel and the driving force of the inner truning wheel, based on the rotation speed difference between the rotation speed of the rear differential device 5R locked by the rear LSD 6R and the rotation speed of the outer turning wheel, which is a driven wheel, and a vertical load difference (load difference) between the inner and outer turning wheels in association with a turning behavior of the vehicle 1. By a calculation method described below, the AWD processor 53 may sequentially calculate the driving force difference between the driving force of the outer turning wheel and the driving force of the inner turning wheel (hereinafter simply referred to as a “driving force difference between the inner and outer turning wheels”) in a region where gripping force of the wheels do not exceed a grip limit and also in a region where the gripping force of the wheels exceed the grip limit.

FIG. 3 is a graph illustrating the calculation method of a driving force difference ΔFx between the inner and outer turning wheels. The graph has a vertical axis representing the driving force difference ΔFx, which is a value representing driving force Fxo of the outer turning wheel minus driving force Fxi of the inner turning wheel, and a horizontal axis representing a rotation speed difference ΔV1, which is a value representing a rotation speed Vwo of the outer driven wheel minus a rotation speed Vd0 of the rear differential device 5R. Hereinafter, the graph illustrated in FIG. 3 may be referred to as “estimated driving force difference data”.

A minimum value ΔFx_min of the driving force difference ΔFx may correspond to a value representing a ground speed difference ΔVg multiplied by driving stiffness Kx of the wheels 2, where the ground speed difference ΔVg is a value representing a ground speed Vgo of the outer turning wheel minus a ground speed Vgi of the inner turning wheel. The ground speed Vgo of the outer turning wheel and the ground speed Vgi of the inner turning wheel are calculated under an assumption that the inner turning wheel and the outer turning wheel are gripping. A maximum value ΔFx_max of the driving force difference ΔFx may correspond to a value representing a ratio of a load difference ΔFz to an axle load Fz, multiplied by a sum Fx of the driving force Fxo of the outer turning wheel and the driving force Fxi of the inner turning wheel, where the load difference ΔFz is a value representing a vertical load Fzo of the outer turning wheel minus a vertical load Fzi of the inner turning wheel. The driving force Fxo and the driving force Fxi are calculated under an assumption that either the inner turning wheel or both the inner and outer turning wheels are slipping. The axle load Fz is a value representing the vertical load Fzo plus the outer turning wheel and the vertical load Fzi of the inner turning wheel.

The driving force difference ΔFx between the inner and outer turning wheels may vary in a linear functional manner, in accordance with the rotation speed difference ΔV1, which is the value representing the rotation speed of the wheel not being locked or slipping due to the braking force (the rotation speed Vwo of the outer driven wheel in the example of the estimated driving force difference data illustrated in FIG. 3) minus the rotation speed Vd0 of the rear differential device 5R. The AWD processor 53 may read sensor signals output from various sensors during traveling of the vehicle 1, determine the rotation speed difference ΔV1 actually generated, and calculate the driving force difference ΔFx, based on the value of the rotation speed difference ΔV1.

In a state where the driving force is 0 (zero) and the rear LSD 6R is locked during turning of the vehicle 1, the rotation speed Vd0 of the rear differential device 5R may become equal to a sum of: a value representing the ground speed Vgo of the outer turning wheel multiplied by a ratio Rzo of the vertical load Fzo to the axle load Fz; and a value representing the ground speed Vgi of the inner turning wheel multiplied by a ratio Rzi of the vertical load Fzi of the inner turning wheel to the axle load Fz (hereinafter, the sum may be also referred to as a “load distribution sum of the ground speeds of the inner and outer wheels”). In this case, the rotation speed difference ΔV1 represented by the horizontal axis of the estimated driving force difference data illustrated in FIG. 3 may become zero, which corresponds to a maximum value ΔV1_max in a region in which the driving force difference ΔFx is to be generated.

In some embodiments, the driving force Fxi of the inner turning wheel and the driving force Fxo of the outer turning wheel may be represented by the following Expressions 1 and 2, respectively.

Fxi=Kxi*(Vd0−Vgi) (1)

Fxo=Kxo*(Vd0−Vgo) (2)
Vgi: Ground speed of inner turning wheel
Vgo: Ground speed of outer turning wheel
Vd0: Rotation speed of differential device (rear differential device)
Kxi: Driving stiffness Kx of wheel ∝ Vertical load Fzi of inner turning wheel
Kxo: Driving stiffness Kx of wheel ∝ Vertical load Fzo of outer turning wheel

The rotation speed Vd0 of the differential device may be an average value of the ground speed Vgi of the inner turning wheel and the groundspeed Vgo of the outer turning wheel. The driving stiffness Kx of the wheels to be used may be recorded in the storage 61 in advance. In the present example embodiment, the vertical load Fzi of the inner turning wheel and the vertical load Fzo of the outer turning wheel may be a vertical load Fzri of the rear inner turning wheel and the vertical load Fzro of the rear outer turning wheel, respectively. These vertical loads may be calculated using the following Expressions 3 to 6.

Fzfi=Fzf0−ΔFzx−ΔFzy*Kzy (3)

Fzri=Fzr0−ΔFzx−ΔFzy*(1-Kzy) (4)

Fzfo=Fzf0−ΔFzx+ΔFzy*Kzy (5)

Fzro=Fzr0-+ΔFzx+ΔFzy*(1-Kzy) (6)
Fzfi: Vertical load of front inner turning wheel
Fzri: Vertical load of rear inner turning wheel
Fzfo: Vertical load of front outer turning wheel
Fzro: Vertical load of rear outer turning wheel
Fzf0: Vertical load of front wheel upon stopping
Fzr0: Vertical load of rear wheel upon stopping
ΔFzx: Longitudinal load transfer amount upon acceleration
ΔFzy: Lateral load transfer amount upon turning
Kzy: Distribution ratio of axle load transfer between right-front wheel and left-front wheel

The vertical load Fzf0 of the front wheel upon stopping, the vertical load Fzr0 of the rear wheel upon stopping, and the distribution ratio Kzy of axle load transfer between the right-front wheel and the left-front wheel may be recorded as vehicle data in the storage 61 in advance. The longitudinal load transfer amount ΔFzx upon acceleration and the lateral load transfer amount ΔFzy upon turning may be represented by the following Expressions 7 and 8, respectively.

$$Δ Fzx = \frac{m * \ddot{x} * hg}{2 * l} \qquad ( 7 )$$

$$Δ Fzy = \frac{m * \ddot{y} * hg}{d} \qquad ( 8 )$$

m: Vehicle mass
x″ (second derivative of x): Longitudinal acceleration
y″ (second derivative of y): Lateral acceleration
hg: Vehicle center of gravity height
l: Wheel base
d: Tread

The vehicle mass m, the vehicle center of gravity height hg, the wheel base l, and the tread d may be recorded as the vehicle data in the storage 61 in advance. The longitudinal acceleration and the lateral acceleration may be determined based on the sensor signals output from the acceleration sensor 17.

The sum of the driving force Fxi of the inner turning wheel and the driving force Fxo of the outer turning wheel determined using Expressions 1 and 2 described above may be represented by the following Expression 9.

Fxi+Fxo=Kxi*(Vd0−Vgi)+Kxo*(Vd0−Vgo)

=(Kxi+Kxo)*Vd0−Kxi*Vgi−Kxo*Vgo

=(Kx0*Fzi+Kx0*Fzo)*Vd0−Kx0*Fzi*Vgi−Kx0*Fzo −Vgo (9)

Kx0: Proportional constant to vertical load of wheel

When the driving force is 0 (zero), the sum of the driving force Fxi of the inner turning wheel and the driving force Fxo of the outer turning wheel may be also 0 (zero). Accordingly, the rotation speed Vd0 of the rear differential device 5R may be represented by the following Expression 10.

Vd0=(Kx0*Fzi*Vgi+Kx0*Fzo*Vgo)/(Kx0*Fzi+Kx0−Fzo)

=(Fzi*Vgi+Fzo−Vgo)/(Fzi+Fzo)

=(Fzi*Vgi+Fzo*Vgo)/Fz (10)

When the vehicle 1 travels straight, the vertical load Fzi of the inner turning wheel and the vertical load Fzo of the outer turning wheel may be equal to each other. The rotation speed Vd0 of the rear differential device 5R may thus be an average value of the ground speed Vgi of the inner turning wheel and the ground speed Vgo of the outer turning wheel. Further, when the vehicle 1 travels straight, the ground speed Vgi of the inner turning wheel and the ground speed Vgo of the outer turning wheel may be equal to each other also for the driven wheels. Accordingly, a value representing the rotation speed Vwo of the outer driven wheel minus the load distribution sum of the ground speeds of the inner and outer wheels (the rotation speed difference ΔV1 represented by the horizontal axis of the estimated driving force difference data illustrated in FIG. 3) may become 0 (zero).

Further, in a state where both the outer turning wheel and the inner turning wheel are gripping, an absolute value |Fxo| may be smaller than or equal to a value representing the vertical load Fzo multiplied by a road-surface friction coefficient μ, an absolute value |Fxi| may be smaller than or equal to a value representing the vertical load Fzi multiplied by the road-surface friction coefficient μ, and the driving force difference ΔFx, which is the value representing the driving force Fxo of the outer turning wheel minus the driving force Fxi of the inner turning wheel, may become a minimum value (the minimum value ΔFx_min of the driving force difference ΔFx of the estimated driving force difference data illustrated in FIG. 3). The minimum value ΔFx_min of the driving force difference ΔFx may be represented by the following Expression 11.

ΔFx_min=(Vgo+Vgi)*Kx=ΔVg*Kx (11)

In contrast, in a state where either the inner turning wheel or both the inner turning wheel and the outer turning wheel are slipping beyond the grip limit of the wheels due to an increase in driving force, the driving force difference ΔFx, which is the value representing the driving force Fxo of the outer turning wheel minus the driving force Fxi of the inner turning wheel, may become a maximum value (the maximum value ΔFx_max of the driving force difference ΔFx of the estimated driving force difference data illustrated in FIG. 3). The maximum value ΔFx_max of the driving force difference ΔFx may be represented by the following Expression 12.

$$ΔFx\_max = Fx * \frac{Fzo - Fzi}{Fz} = Fx * Δ Fz / Fz \qquad ( 12 )$$

Fx: Sum of driving force of inner turning wheel and driving force of outer turning wheel
ΔFz: Vertical load difference between inner and outer turning wheels

Since the vertical load Fzi of the inner turning wheel and the vertical load Fzo of the outer turning wheel are equal to each other when the vehicle 1 travels straight, both the maximum value ΔFx_max and the minimum value ΔFx_min of the driving force difference ΔFx represented by the vertical axis of the estimated driving force difference data illustrated in FIG. 3 may become 0 (zero). In this case, the driving force difference ΔFx between the inner and outer turning wheels may become 0 (zero) regardless of the value of the rotation speed difference ΔV1 represented by the horizontal axis.

In this way, the AWD processor 53 may estimate the maximum value ΔFx_max and the minimum value ΔFx_min of the driving force difference ΔFx between the inner and outer turning wheels, based on the sensor signals output from various sensors, during traveling of the vehicle 1, and calculate the maximum value ΔV1_max of the rotation speed difference ΔV1, which is the value representing the rotation speed Vwo of the outer driven wheel minus the load distribution sum of the ground speeds of the inner and outer wheels, using the following Expression 13. The AWD processor 53 may determine the rotation speed difference ΔV1 actually generated, and calculate the driving force difference ΔFx from the value of the rotation speed difference ΔV1, based on a correlation between the driving force difference ΔFx and the rotation speed difference ΔV1.

ΔV1_max=|y|*d/2 (13)

y: Yaw rate

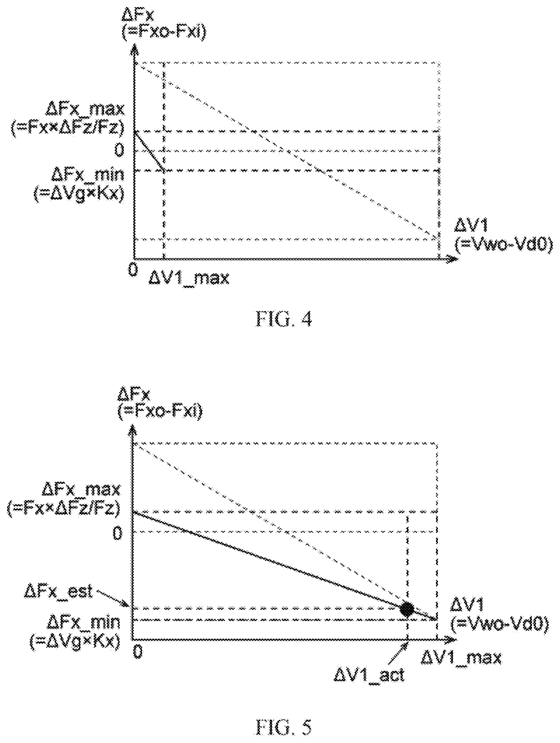

FIG. 4 illustrates an example of the estimated driving force difference data in a case where the rear differential device 5R is locked when the vehicle 1 travels substantially straight. When the vehicle 1 travels substantially straight, the ground speed difference AVg, which is the value representing the ground speed Vgo of the outer turning wheel minus the ground speed Vgi of the inner turning wheel, and the load difference ΔFz, which is the value representing the vertical load Fzo of the outer turning wheel minus the vertical load Fzi of the inner turning wheel, may approach 0 (zero). In this case, the driving force difference ΔFx between the inner and outer turning wheels may approach 0 (zero) regardless of the value of the rotation speed difference ΔV1 represented by the horizontal axis.

FIG. 5 illustrates an example of the estimated driving force difference data in a case where the rear differential device 5R is locked and both the outer turning wheel and the inner turning wheel are gripping during turning of the vehicle 1.

FIG. 6 illustrates the driving force Fxo of the outer turning wheel and the driving force Fxi of the inner turning wheel to be generated when the vehicle 1 turns left. As illustrated in FIG. 6, when both the outer turning wheel and the inner turning wheel are gripping, the driving force Fxo of the outer turning wheel may take a negative value. Accordingly, a yaw moment Mu in an understeer direction may act on the vehicle 1. In this case, the ground speed difference ΔVg, which is the value representing the ground speed Vgo of the outer turning wheel minus the ground speed Vgi of the inner turning wheel, may take a positive value, and the minimum value ΔFx_min of the driving force difference ΔFx, which is the value representing the driving force Fxo of the outer turning wheel minus the driving force Fxi of the inner turning wheel, may increase in a negative direction. Further, the maximum value ΔFx_max of the driving force difference ΔFx may take a value corresponding to the load difference ΔFz, which is the value representing the vertical load Fzo of the outer turning wheel minus the vertical load Fzi of the inner turning wheel.

While the moment in the understeer direction is applied to the vehicle 1, the load distribution sum of the ground speeds of the inner and outer wheels may become smaller than the rotation speed Vwo of the outer driven wheel, and an actual rotation speed difference ΔV1_act, which is a value representing the rotation speed Vwo of the outer driven wheel minus the load distribution sum of the ground speeds of the inner and outer wheels, may take a large value. Accordingly, a driving force difference ΔFx_est, which is a value representing the driving force Fxo of the outer turning wheel minus the driving force Fxi of the inner turning wheel, may be calculated as a negative value.

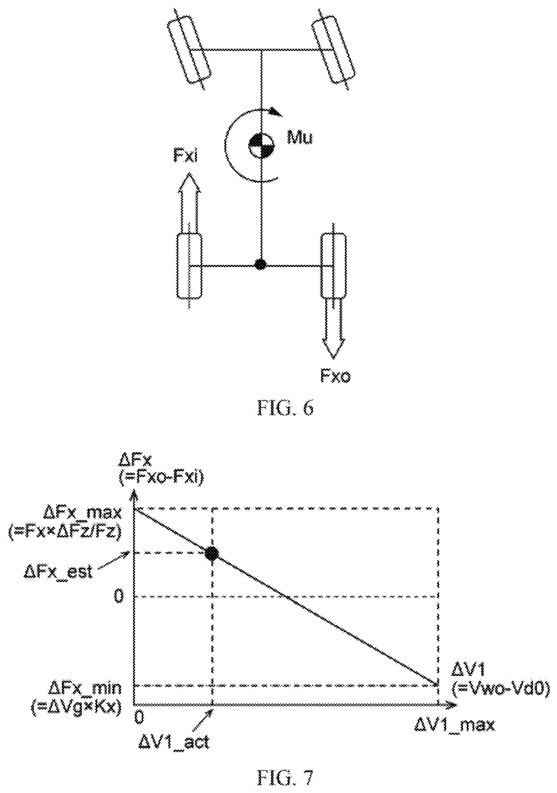

FIG. 7 illustrates an example of the estimated driving force difference data in a case where the rear differential device 5R is locked and either the inner turning wheel or both the inner turning wheel and the outer turning wheel are slipping during turning of the vehicle 1.

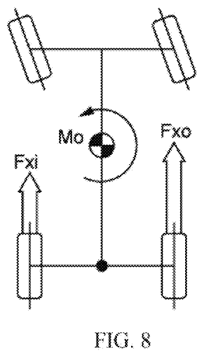

FIG. 8 illustrates the driving force Fxo of the outer turning wheel and the driving force Fxi of the inner turning wheel to be generated when the vehicle 1 turns left. As illustrated in FIG. 8, when either the inner turning wheel or both the inner turning wheel and the outer turning wheel are slipping, the driving force Fxo of the outer turning wheel may become greater than the driving force Fxi of the inner turning wheel. Accordingly, a yaw moment Mo in an oversteer direction may be to the vehicle 1. In this case, the ground speed difference ΔVg, which is the value representing the ground speed Vgo of the outer turning wheel minus the ground speed Vgi of the inner turning wheel, may take a positive value, and the minimum value ΔFx_min of the driving force difference ΔFx, which is the value representing the driving force Fxo of the outer turning wheel minus the driving force Fxi of the inner turning wheel, may increase in the negative direction. Further, the maximum value ΔFx_max of the driving force difference ΔFx may increase in a positive direction as the load difference ΔFz, which is the value representing the vertical load Fzo of the outer turning wheel minus the vertical load Fzi of the inner turning wheel, increases.

While the moment in the oversteer direction is applied to the vehicle 1, the difference between the load distribution sum of the ground speeds of the inner and outer wheels and the rotation speed Vwo of the outer driven wheel may become smaller, and the rotation speed difference ΔV1, which is the value representing the rotation speed Vwo of the outer driven wheel minus the sum of the load distributions of the ground speeds of the inner and outer wheels, may approach zero. Accordingly, the driving force difference ΔFx_est, which is the value representing the driving force Fxo of the outer turning wheel minus the driving force Fxi of the inner turning wheel, may be calculated as a positive value.

### <4. Operation of Control Apparatus>

Next, a description will be given of an exemplary processing operation to be performed by the processing unit 51 of the vehicle control apparatus 50 according to the present example embodiment, with reference to flowcharts.

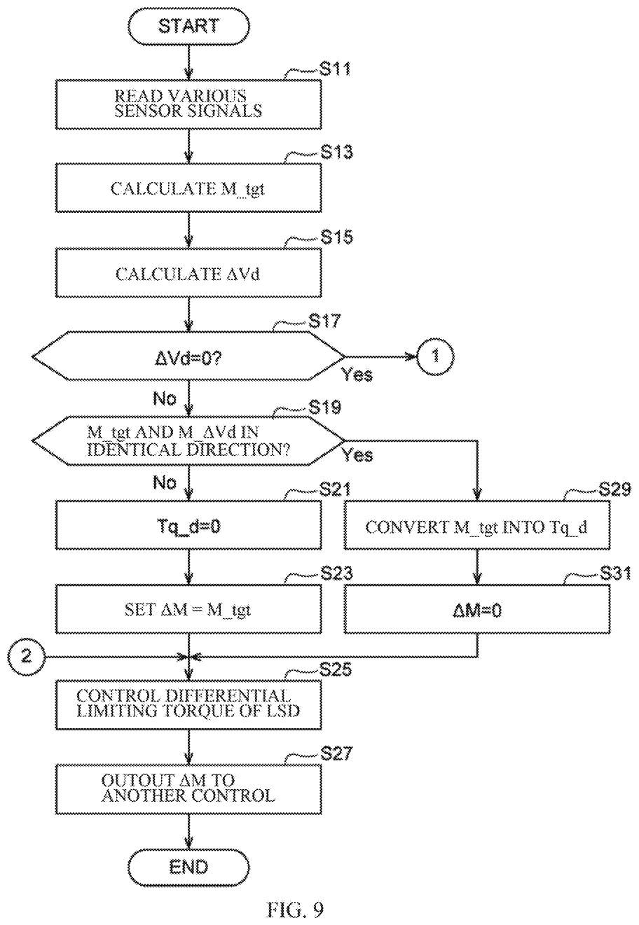

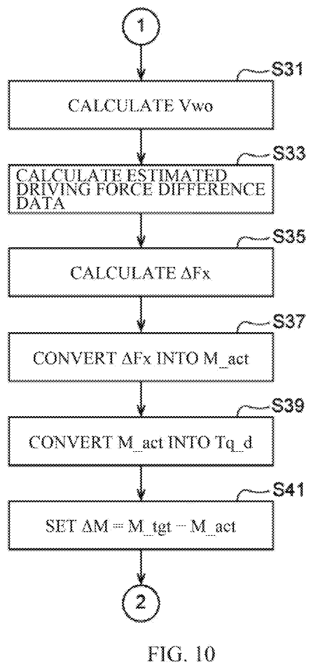

FIGS. 9 and 10 illustrate an exemplary routine of the processing operation to be performed by the vehicle control apparatus 50. In the following, an example is described in which the rear LSD 6R of the rear differential device 5R is controlled. The routine illustrated in FIGS. 9 and 10 may be repeatedly executed while the driving system of the vehicle 1 is operating.

First, the AWD processor 53 of the vehicle control apparatus 50 may read sensor signals output from various sensors provided in the vehicle 1 (Step S11). In some embodiments, the AWD processor 53 may acquire sensor signals output from the wheel speed sensor 11, the accelerator position sensor 13, the steering angle sensor 15, the acceleration sensor 17, and the yaw rate sensor 19 in a predetermined sampling period, and detect the rotation speed of each wheel 2, an accelerator position, a steering angle, an acceleration rate, and a yaw rate of the vehicle 1.

Next, the AWD processor 53 may calculate a target yaw moment M_tgt of the vehicle 1 (Step S13). In some embodiments, the AWD processor 53 may calculate a target yaw rate by a known method, and calculate a target yaw moment, based on the target yaw rate and an inertia moment and aerodynamic moment of the vehicle 1. The target yaw rate may be calculated by a known calculation method, based on the ground speed V, the wheel base 1, and a turning radius R of the vehicle 1, for example. The inertia moment and aerodynamic moment of the vehicle 1 may be recorded as the vehicle data in the storage 61 in advance.

Thereafter, the AWD processor 53 may calculate differential rotation ΔVd of the rear differential device 5R (Step S15). In some embodiments, the AWD processor 53 may calculate the differential rotation ΔVd by subtracting the rotation speed of the inner turning wheel from the rotation speed of the outer turning wheel of the rear wheels 2R. Thereafter, the AWD processor 53 may determine whether the calculated differential rotation ΔVd is 0 (zero) (Step S17). In some embodiments, the AWD processor 53 may determine that the differential rotation ΔVd is 0 (zero) even when the differential rotation ΔVd is not exactly 0 (zero) but within a predetermined error range.

If it is not determined that the calculated differential rotation ΔVd is 0 (zero) (Step S17: No), the AWD processor 53 may determine whether the turning direction of the vehicle 1 indicated by the target yaw moment M_tgt and the turning direction of the vehicle 1 indicated by a yaw moment M_ΔVd generated by the differential rotation ΔVd of the rear differential device 5R are identical to each other (Step S19). In other words, when the rear differential device 5R performs a differential operation, the AWD processor 53 may determine whether the target yaw moment M_tgt is achievable by controlling the rear LSD 6R without changing a current differential direction.

The turning direction of the vehicle 1 indicated by the target yaw moment M_tgt and the turning direction of the vehicle 1 indicated by the yaw moment M_ΔVd generated by the differential rotation ΔVd of the rear differential device 5R are identical to each other, the target yaw moment M_tgt may be achievable by controlling the rear LSD 6R without changing the current differential direction.

Accordingly, if it is determined that the turning direction of the vehicle 1 indicated by the target yaw moment M_tgt and the turning direction of the vehicle 1 indicated by the yaw moment M_ΔVd generated by the differential rotation ΔVd of the rear differential device 5R are identical to each other (Step S19: Yes), the AWD processor 53 may convert the target yaw moment M_tgt into a differential limiting torque Tq_d of the rear LSD 6R (Step S29). In some embodiments, the AWD processor 53 may convert the target yaw moment M_tgt into the differential limiting torque Tq_d by a known calculation method, based on a speed ratio and transmission efficiency of the rear differential device 5R.

Thereafter, the AWD processor 53 may set an additional yaw moment ΔM, which is a shortfall of the yaw moment generated solely by the differential limiting torque of the rear LSD 6R, to 0 (zero) (Step S31), following which the processing may proceed to Step S25.

If it is not determined that the turning direction of the vehicle 1 indicated by the target yaw moment M_tgt and the turning direction of the vehicle 1 indicated by the yaw moment M_AVd generated by the differential rotation ΔVd of the rear differential device 5R are identical to each other (Step S19: No), it may be necessary to change the current differential direction by controlling the rear LSD 6R, to achieve the target yaw moment M_tgt. In this case, the AWD processor 53 may control the yaw moment of the vehicle 1 by performing another control without controlling the yaw moment of the vehicle 1 by controlling the rear LSD 6R.

Accordingly, if it is not determined that the turning direction of the vehicle 1 indicated by the target yaw moment M_tgt and the turning direction of the vehicle 1 indicated by the yaw moment M_ΔVd generated by the differential rotation ΔVd of the rear differential device 5R are identical to each other (Step S19: No), the AWD processor 53 may set the differential limiting torque Tq_d of the rear LSD 6R to 0 (zero) (Step S21).

Thereafter, the AWD processor 53 may set the value of the target yaw moment M_tgt as the value of the additional yaw moment ΔM, which is a shortfall to the target yaw moment M_tgt (Step S23), following which the processing may proceed to Step S25.

If it is determined in Step S17 described above that the calculated differential rotation ΔVd is 0 (zero) (Step S17: Yes), the AWD processor 53 may calculate the rotation speed Vwo of the outer driven wheel (Step S31). The rotation speed Vwo of the outer driven wheel may be used as an alternative value of a ground speed of a wheel less likely to cause locking or slipping due to a braking force. In the present example embodiment, the value of the rotation speed of the outer truning wheel of the front wheels 2F may be used.

Thereafter, the AWD processor 53 may calculate the estimated driving force difference data (refer to FIG. 3), based on the data obtained from the sensor signals read by the AWD processor 53 (Step S33). The AWD processor 53 may define, as the minimum value ΔFx_min of the driving force difference ΔFx, a value representing the ground speed difference ΔVg multiplied by the driving stiffness Kx of the wheels 2, where the ground speed difference ΔVg is a value representing the ground speed Vgo of the outer turning wheel minus the ground speed Vgi of the inner turning wheel, and the ground speeds Vgo and Vgi are calculated under the assumption that either the inner turning wheel or both the inner turning wheel and the outer turning wheel are gripping. Further, the AWD processor 53 may define, as the maximum value ΔFx_max of the driving force difference ΔFx, a value representing the ratio of the load difference ΔFz to the axle load Fz, multiplied by the sum Fx of the driving force Fxo of the outer turning wheel and the driving force Fxi of the inner turning wheel, where the load difference ΔFz is a value representing the vertical load Fzo of the outer turning wheel minus the vertical load Fzi of the inner turning wheel. The vertical load Fzo of the outer truning wheel and the vertical load Fzi of the inner turning wheel are calculated under the assumption that either the inner turning wheel or both the inner turning wheel and the outer turning wheel are slipping.

Further, the AWD processor 53 may define that the driving force difference ΔFx takes the maximum value ΔFx_max, when the value of the rotation speed difference ΔV1, which is the value representing the rotation speed Vwo of the outer turning wheel minus the rotation speed Vd0 of the rear differential device 5R, becomes zero. Further, the AWD processor 53 may define that the driving force difference ΔFx takes the minimum value ΔFx_min, when the value of the rotation speed difference ΔV1 becomes the value representing the rotation speed Vwo of the outer turning wheel minus the sum of: the value representing the ground speed Vgo of the outer turning wheel multiplied by the ratio Rzo of the vertical load Fzo of the outer turning wheel to the axle load Fz; and the value representing the ground speed Vgi of the inner turning wheel multiplied by the ratio Rzi of the vertical load Fzi of the inner turning wheel to the axle load Fz. The AWD processor 53 may calculate a slope of the change in the driving force difference ΔFx with respect to the change in the rotation speed difference ΔV1 under an assumption that the driving force difference ΔFx between the inner and outer turning wheels varies in proportion to the value of the rotation speed difference ΔV1, and set the slope as the estimated driving force difference data.

Thereafter, the AWD processor 53 may calculate the driving force difference ΔFx from the estimated driving force difference data thus set, based on the value of the actual rotation speed difference ΔV1 (Step S35). In some embodiments, the AWD processor 53 may calculate the actual rotation speed difference ΔV1_act by subtracting the rotation speed Vd0 of the rear differential device 5R from a rotation speed Awo of the outer driven wheel obtained based on the sensor signal, and determine the driving force difference ΔFx corresponding to the rotation speed difference ΔVi_act, based on the estimated driving force difference data.

Thereafter, the AWD processor 53 may calculate an acting yaw moment M_act applied to the vehicle 1, based on the driving force difference ΔFx (Step S37). In some embodiments, the AWD processor 53 may calculate the acting yaw moment M_act using the following Expression 14.

M_act=ΔFx*d/2 (14)

### d: Tred

Thereafter, the AWD processor 53 may convert the calculated acting yaw moment M_act into the differential limiting torque Tq_d (Step S39). In some embodiments, the AWD processor 53 may convert the acting yaw moment M_act into the differential limiting torque Tq_d by a known calculation method, based on a speed ratio and transmission efficiency of the rear differential device 5R.

Thereafter, the AWD processor 53 may set a value representing the target yaw moment M_tgt minus the acting yaw moment M_act, as the value of the additional yaw moment ΔM, which is a shortfall to the target moment M_tgt (Step S41), following which the processing may proceed to Step S25.

After setting the differential limiting torque Tq_d and the additional yaw momentΔM in the respective steps, the AWD processor 53 may send a command to the rear LSD driver 45, thereby controlling the differential limiting torque Tq_d to be generated from the rear LSD 6R (Step S25).

Further, the AWD processor 53 may output the additional yaw moment ΔM as a target value for another control (Step S27). In some embodiments, the AWD processor 53 may output, to the brake processor 55, a command that causes the vehicle 1 to additionally generate the additional yaw momentΔM. The brake processor 55 may individually control the braking force to be generated by the brake device 9 of each wheel 2, and generate a yaw moment corresponding to the additional yaw moment ΔM, based on a braking force difference between the wheels 2. In some embodiments, the AWD processor 53 may additionally generate the additional yaw moment ΔM by varying a distribution rate of the driving force to the front wheel 2F and the rear wheel 2R using the center differential device 5C, instead of controlling the braking devices 9. In some embodiments, the AWD processor 53 may additionally generate the additional yaw moment ΔM using one or more other control elements configured to apply a yaw moment to the vehicle 1.

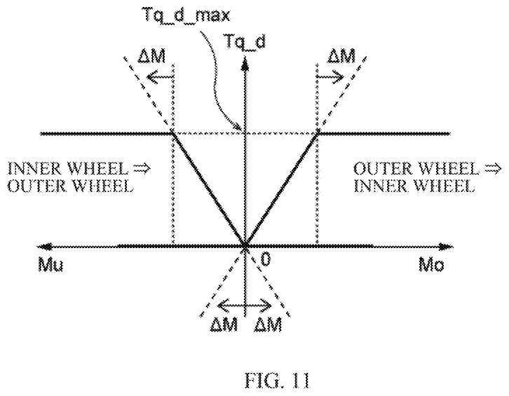

FIG. 11 is a graph illustrating an exemplary setting of the differential limiting torque Tq_d to be performed by the vehicle control apparatus 50 according to the present example embodiment. The graph has a horizontal axis representing the target yaw moment M_tgt of the vehicle 1, in which a right-side portion of the horizontal axis represents the yaw moment Mo in the oversteer direction, and a left-side portion of the horizontal axis represents the yaw moment Mu in the understeer direction. The graph has a vertical axis representing the differential limiting torque Tq_d.

When the generated differential limiting torque Tq_d is smaller than or equal to an upper limit Tq_d_max, the AWD processor 53 may control the differential limiting torque Tq_d by controlling the LSD of the differential device so that the yaw moment M of the vehicle 1 becomes the target yaw moment M_tgt.

However, when the turning direction of the vehicle 1 indicated by the target yaw moment M_tgt and the turning direction of the vehicle 1 indicated by the yaw moment M_ΔVd generated by the differential rotation ΔVd of the rear differential device 5R are not identical to each other (in a region illustrated in FIG. 11 in which the differential limiting torque Tq_d takes a nagative value), the AWD processor 53 may perform another control so that the yaw moment M of the vehicle 1 becomes the target yaw moment M_tgt, instead of controlling the differential limiting torque Tq_d of the LSD of the differential device.

When the differential mechanism is locked by the LSD of the differential device and the generated differential limiting torque Tq_d becomes greater than the upper limit Tq_d_max, the AWD processor 53 may set the differential limiting torque Tq_d of the LSD of the differential device as the upper limit Tq_d_max, and additionally generate the additional yaw moment ΔM by the other control so that the yaw moment M of the vehicle 1 becomes the target yaw moment M_tgt.

### <5. Effect>

As described above, the vehicle control apparatus 50 according to the present example embodiment is a vehicle control apparatus configured to control a vehicle including the differential device. The differential device includes the differential mechanism configured to distribute driving force between the inner turning wheel and the outer turning wheel, and the limited slip differential configured to restrict the differential rotation between the inner turning wheel and the outer turning wheel. The vehicle control apparatus 50 includes one or more processors and one or more memories communicably coupled to the one or more processors. The one or more processors are configured to calculate the driving force difference ΔFx, based on the rotation speed difference ΔV1. The driving force ΔFx is the value representing the driving force Fxo of the outer turning wheel minus the driving force Fxi of the inner turning wheel. The rotation speed difference ΔV1 is the value representing the rotation speed Vwo of the outer turning wheel minus the rotation speed Vd0 of the differential device.

Accordingly, it is possible to quantitatively and continuously determine the driving force difference ΔFx between the inner and outer turning wheels regardless of whether the wheels are gripping or whether the wheels are slipping beyond the grip limit. It is therefore possible to quantitatively control the yaw moment to act on the vehicle 1, based on the driving force difference ΔFx, even when the wheels are slipping and the differential mechanism is locked.

Further, the vehicle control apparatus 50 according to the present example embodiment may define, as the minimum value ΔFx_min of the driving force difference ΔFx, the value representing the ground speed difference ΔVg multiplied by the driving stiffness Kx of the wheels 2. The ground speed difference ΔVg is the value representing the ground speed Vgo of the outer turning wheel minus the ground speed Vgi of the inner turning wheel, and the ground speed Vgo of the outer turning wheel and the ground speed Vgi of the inner turning wheel are calculated under the assumption that the inner turning wheel and the outer turning wheel are gripping. The vehicle control apparatus 50 may define, as the maximum value ΔFx_max of the driving force difference ΔFx, the value representing the ratio of the load difference ΔFz to the axle load Fz, multiplied by the sum Fx of the driving force Fxo of the outer turning wheel and the driving force Fxi of the inner turning wheel. The load difference ΔFz is the value representing the vertical load Fzo of the outer turning wheel minus the vertical load Fzi of the inner turning wheel, and the vertical load Fzo of the outer turning wheel and the vertical load Fzi of the inner turning wheel are calculated under the assumption that either the inner turning wheel or both the inner turning wheel and the outer turning wheel are slipping.

Accordingly, it is possible to calculate the minimum value ΔFx_min and the maximum value ΔFx_max of the driving force difference ΔFx between the inner and outer turning wheels to be possibly generated in a current traveling state of the vehicle 1, and to set a range of the driving force difference ΔFx to be possibly generated.

Further, the vehicle control apparatus 50 according to the present example embodiment may define that the driving force difference ΔFx takes the maximum value ΔFx_max, when the value of the rotation speed difference ΔV1 between the rotation speed Vwo of the outer turning wheel and the rotation speed Vd0 of the differential device is zero. The vehicle control apparatus 50 may define that the driving force difference ΔFx takes the minimum value ΔFx_min, when the value of the rotation speed difference ΔV1 becomes the value representing the rotation speed Vwo of the outer turning wheel minus the sum of: the value representing the ground speed Vgo of the outer turning wheel multiplied by the ratio Rzo of the vertical load Fzo of the outer turning wheel to the axle load Fz; and the value representing the ground speed Vgi of the inner turning wheel multiplied by the ratio Rzi of the vertical load Fzi of the inner turning wheel to the axle load Fz, and calculate the driving force difference ΔFx, based on an actual value of the rotation speed difference ΔV1.

Accordingly, it is possible to quantitatively determine the driving force difference ΔFx in accordance with an actual value of the rotation speed difference ΔV1 after setting conditions under which the minimum value ΔFx_min and the maximum value ΔFx_max of the driving force difference ΔFx may respectively occur. It is therefore possible to quantitatively and continuously calculate the driving force difference ΔFx between the inner and outer turning wheels regardless of whether the wheels are gripping or are slipping beyond the grip limit and the differential mechanism is locked.

Further, the vehicle control apparatus 50 according to the present example embodiment may determine whether the differential rotation ΔVd between the outer turning wheel and the inner turning wheel is zero. When the differential rotation ΔVd is zero, the vehicle control apparatus 50 may calculate the driving force difference ΔFx, determine the acting yaw moment M_act applied to the vehicle 1, based on the driving force difference ΔFx, and calculate the differential limiting torque Tq_d of the differential device, based on the acting yaw moment M_act.

Accordingly, it is possible to calculate the yaw moment generated by the differential device, based on the driving force difference ΔFx and to determine the differential limiting torque generated by the limited slip differential, regardless of whether the wheels are gripping or are slipping beyond the grip limit.

Further, when the acting yaw moment M_act is smaller than the target yaw moment M_tgt of the vehicle 1, the vehicle control apparatus 50 according to the present example embodiment may generate the additional yaw moment ΔM to compensate for a yaw rate shortfall with an additional yaw moment generated by a yaw moment applier other than the differential device.

Accordingly, when it is difficult to generate a sufficient yaw moment solely by controlling the differential limiting torque generated by the limited slip differential, or when the rotation direction of the yaw moment of the vehicle 1 indicated by the differential direction of the differential device differs from the rotation direction of the target yaw moment of the vehicle 1, it is possible to generate the additional yaw moment by another control, thereby causing the yaw moment applied to the vehicle 1 to correspond to the target yaw moment.

According to the example embodiments of the disclosure described above, it is possible to control the yaw moment to act on the vehicle, based on the driving force difference between the inner and outer turning wheels, even when the differential mechanism is locked beyond the grip limit of the wheels.

Although some example embodiments of the disclosure have been described in the foregoing by way of example with reference to the accompanying drawings, the disclosure is by no means limited to the embodiments described above. It should be appreciated that modifications and alterations may be made by persons skilled in the art without departing from the scope as defined by the appended claims. The disclosure is intended to include such modifications and alterations in so far as they fall within the scope of the appended claims or the equivalents thereof.

In some embodiments, the rotation speed Vwo of the outer driven wheel, which is a reference value of the horizontal axis of the estimated driving force difference data illustrated in FIG. 3, may be a value obtained by converting the ground speed V of the vehicle 1 calculated by a known calculation method into the ground speed Vgo of the outer turning wheel, using the following expression.

Vgo=V+|y|×d/2

In some embodiments, the rotation speed Vwo of the outer driven wheel, which is a reference value of the horizontal axis of the estimated driving force difference data illustrated in FIG. 3, may be a ground speed of the driving wheel at a lateral center position. The ground speed of the driving wheel at the lateral center position may be determined as an average value of the ground speeds of the inner and outer turning wheels.

The calculation method of the driving force difference ΔFx between the inner and outer turning wheels in the state where the differential mechanism of the differential device is locked may be used to estimate an actual differential limiting torque of a mechanical LSD other than the electronically-controlled LSD. In this case, it is possible to accurately estimate the differential limiting torque generated by the mechanical LSD and to calculate a yaw moment shortfall. It is therefore possible to generate an additional moment by another control, thereby causing the yaw moment applied to the vehicle to correspond to the target yaw moment.

In the above-described example embodiment, the differential limiting torque of the rear differential device is controlled in the four-wheel drive vehicle including the center differential device configured to distribute driving force output from the driving power source to the front and rear wheels. However, the technology of the present disclosure may be applied to control of a differential limiting torque of the front differential device, or may be applied to respective control of the front differential device and the rear differential device.

In the above-described example embodiment, the vehicle control apparatus for the four-wheel drive including the center differential device configured to distribute driving force output from the driving power source to the front and rear wheels is described as an example. However, the technology of the disclosure may be applied to a vehicle control apparatus for a vehicle including a front-wheel drive motor and a rear-wheel drive motor that are provided independently from each other. In this case, the vehicle control apparatus may individually control the driving force to a front-wheel side and the driving force to the rear-wheel side.

Further, the technology of the disclosure may be implementable as a vehicle including the control apparatus described in the above-described example embodiment, a control method to be performed by the control apparatus, a program that causes a computer to serve as the control apparatus, or a non-transitory tangible recording medium that stores the program.

The limitations in the claims are to be interpreted broadly based on the language employed in the claims and not limited to examples described in this specification or during the prosecution of the application, and the examples are to be construed as non-exclusive. As used in this specification and the appended claims, the singular forms “a,” “an,” and “the” include, especially in the context of the claims, are to be construed to cover both the singular and the plural, unless otherwise indicated herein or clearly contradicted by context. Throughout this specification and the appended claims, unless the context requires otherwise, the terms “comprise”, “include”, “have”, and their variations are to be construed to cover the inclusion of a stated element, integer, or step but not the exclusion of any other non-stated element, integer, or step. The term “substantially” and its variants having the similar meaning thereto are defined as being largely but not necessarily wholly what is specified as understood by one of ordinary skill in the art. The term “disposed on/provided on” and its variants having the similar meaning thereto as used herein refer to elements disposed directly in contact with each other or indirectly by having intervening structures therebetween.

The vehicle control apparatus 50 illustrated in FIGS. 1 and 2 is implementable by circuitry including at least one semiconductor integrated circuit such as at least one processor (e.g., a central processing unit (CPU)), at least one application specific integrated circuit (ASIC), and/or at least one field programmable gate array (FPGA). At least one processor is configurable, by reading instructions from at least one machine readable non-transitory tangible medium, to perform all or a part of functions of the vehicle control apparatus illustrated in FIGS. 1 and 2. Such a medium may take many forms, including, but not limited to, any type of magnetic medium such as a hard disk, any type of optical medium such as a CD and a DVD, any type of semiconductor memory (i.e., semiconductor circuit) such as a volatile memory and a non-volatile memory. The volatile memory may include a DRAM and a SRAM, and the nonvolatile memory may include a ROM and a NVRAM. The ASIC is an integrated circuit (IC) customized to perform, and the FPGA is an integrated circuit designed to be configured after manufacturing in order to perform, all or a part of the functions of the vehicle control apparatus 50 illustrated in FIGS. 1 and 2.

1. A vehicle control apparatus configured to control a vehicle,
the vehicle comprising
a differential device comprising:
a differential mechanism configured to distribute driving force between an inner turning wheel and an outer turning wheel; and
a limited slip differential configured to restrict differential rotation between the inner turning wheel and the outer turning wheel,
the vehicle control apparatus comprising:
one or more processors configured to calculate a driving force difference, based on a rotation speed difference, the driving force difference being a value representing driving force of the outer turning wheel minus driving force of the inner turning wheel, the rotation speed difference being a value representing a rotation speed of the outer turning wheel minus a rotation speed of the differential device; and
one or more memories communicably coupled to the one or more processors.

2. The vehicle control apparatus according to claim 1, wherein
the one or more processors are configured to
define, as a minimum value of the driving force difference, a value representing a ground speed difference multiplied by driving stiffness of wheels of the vehicle, the ground speed difference being a value representing a ground speed of the outer turning wheel minus a ground speed of the inner turning wheel, the ground speed of the outer turning wheel and the ground speed of the inner turning wheel being calculated under an assumption that the inner turning wheel and the outer turning wheel are gripping, and
define, as a maximum value of the driving force difference, a value representing a ratio of a load difference to an axle load, multiplied by a sum of the driving force of the outer turning wheel and the driving force of the inner turning wheel, the load difference being a value representing a vertical load of the outer turning wheel minus a vertical load of the inner turning wheel, the vertical load of the outer turning wheel and the vertical load of the inner turning wheel being calculated under an assumption that either the inner turning wheel or both the inner turning wheel and the outer turning wheel are slipping.

3. The vehicle control apparatus according to claim 2, wherein
the one or more processors are configured to
define that the driving force difference takes the maximum value, when a value of the rotation speed difference becomes zero,
define that the driving force difference takes the minimum value, when the value of the rotation speed difference becomes a value representing the rotation speed of the outer turning wheel minus the sum of: a value representing the ground speed of the outer turning wheel multiplied by a ratio of the vertical load of the outer turning wheel to the axle load; and a value representing the ground speed of the inner turning wheel multiplied by a ratio of the vertical load of the inner turning wheel to the axle load, and
calculate the driving force difference, based on an actual value of the rotation speed difference.

4. The vehicle control apparatus according to claim 1, wherein
the one or more processors are configured to
determine whether the differential rotation between the outer turning wheel and the inner turning wheel is zero, and
when the differential rotation is zero, calculate the driving force difference, determine an acting yaw moment applied to the vehicle, based on the driving force difference, and calculate a differential limiting torque of the differential device, based on the acting yaw moment.

5. The vehicle control apparatus according to claim 3, wherein
the one or more processors are configured to
determine whether the differential rotation between the outer turning wheel and the inner turning wheel is zero, and
when the differential rotation is zero, calculate the driving force difference, determine an acting yaw moment applied to the vehicle, based on the driving force difference, and calculate a differential limiting torque of the differential device, based on the acting yaw moment.

6. The vehicle control apparatus according to claim 4, wherein the one or more processors are configured to, when the acting yaw moment is smaller than a target yaw moment of the vehicle, compensate for a yaw moment shortfall with an additional yaw moment generated by a yaw moment applier other than the differential device.

7. The vehicle control apparatus according to claim 5, wherein the one or more processors are configured to, when the acting yaw moment is smaller than a target yaw moment of the vehicle, compensate for a yaw moment shortfall with an additional yaw moment generated by a yaw moment applier other than the differential device.
